(19) United States
(12) Patent Application Publication
(10) Pub. No.: US 2014/0358781 A1
(43) Pub. Date: Dec. 4, 2014

(54) SYSTEM AND METHOD FOR AUTHENTICATING AND SECURING ONLINE PURCHASES

(71) Applicant: Gary David Zeigler, North Canton, OH (US)

(72) Inventor: Gary David Zeigler, North Canton, OH (US)

(21) Appl. No.: 14/076,799

(22) Filed: Nov. 11, 2013

Related U.S. Application Data
(60) Provisional application No. 61/855,942, filed on May 28, 2013.

(51) Int. Cl. G06Q 20/40

(52) U.S. Cl. CPC G06Q 20/40
USPC 705/44

(57) ABSTRACT

The present invention relates to authenticating and securing online purchases. The present invention recognizes that an account holder may initiate a financial transaction from a home computer, cellular telephone, or some other electronic device or node which the account holder controls. Prior to initiating an online purchase, the present invention requires the account holder to upload or provide a unique identifier associated with the node to the financial institution associated with the financial account of the user. The financial account may thereafter check whether the request for an online transaction was initiated with the trusted node by comparing the unique identifier of the requesting node with the unique identifier on file for the user. If the unique identifiers match, the financial institution authenticates the financial transaction and allows it to proceed. If the unique identifiers do not match, the financial institution rejects the financial transaction.

### CROSS-REFERENCE TO RELATED APPLICATION

This application claims priority from U.S. Provisional Application Ser. No. 61/855,942, filed May 28, 2013, the disclosure of which is incorporated herein by reference.

### BACKGROUND OF THE INVENTION

1. Technical Field

The present invention relates to authenticating and securing online purchases. More particularly, the present invention relates to facilitating a financial transaction only when requested from a trusted node. Specifically, the present invention relates to providing a unique identifier of a node to a financial institution for use in authenticating future financial transactions.

2. Background Information

Increased use of communication and Internet technology has altered the landscape of information delivery and has affected numerous aspects of life, including commerce and finance. This technological development has enabled individuals to participate in various business transactions within an Internet marketplace. In these online transactions, electronic payments between transacting parties have become increasingly prevalent as the accessibility of the technology to enable such payments has increased. Internet-based vendors typically depend on electronic payment services and may accept a number of electronic payment instruments (e.g. credit cards, debit cards, etc.) and other electronic payment services such as the PayPal™ online payment service. Conventionally, in an online identification and authorization system the user is required to provide a user identification name and password and personal details in order to purchase content from a website or gain access to content. Along with this information, the user is required to provide the identification number of the payment instrument, for example a credit card number. The credit card number is cross-referenced with the owner's name and other basic personal details and if there is a match, the payment is authorized.

If a payment instrument number and associated data is stolen, a thief only needs to enter the information in the same manner as an authorized instrument holder. The systems which authorize and allow payments make no distinction between a thief entering the correct information or a true authorized entity entering the correct information, as long as the desired input matches. Thus, there is a tremendous need in the art for overcoming this significant security flaw in contemporary systems.

### SUMMARY

In one aspect, the invention may provide a method for authenticating and securing online purchases, the method comprising the steps of: initiating an online payment of an amount from a payor to a payee, wherein the payor initiates the online payment via a computer system; providing, by the payor, a unique identifier of the computer system, a financial account identifier, and an amount to the payee; providing, by the payee, the unique identifier, the financial account identifier, and the amount to a financial institution associated with the financial account identifier; determining, by the financial institution, whether the unique identifier is associated with the financial account identifier; completing the online payment by crediting the payee the amount and debiting the payor the amount if the unique identifier is associated with the financial identifier; and rejecting the online payment if the unique identifier is not associated with the financial identifier.

In another aspect, the invention may provide a method for authenticating and securing online purchases, the method comprising the steps of: linking a node and a financial account, wherein the node includes a processor, a memory, and a logic circuit; allowing payment for online purchases via the financial account when the online purchase is initiated by the node; and disallowing payment for online purchases via the financial account when the online purchase is not initiated by the node.

In another aspect, the invention may provide a method for authenticating and securing online purchases, the system comprising: storing a plurality of financial account identifiers in a storage system of a financial institution; associating a first financial account identifier in the plurality of financial account identifiers with an account holder of the financial institution; entering a first unique identifier of a node associated with the account holder into a plurality of unique identifiers in the storage system of the financial institution; and associating the first unique identifier with the first financial account identifier in the storage system.

### BRIEF DESCRIPTION OF THE SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a diagrammatic view of a node communicating with a financial institution of one embodiment of the present invention;

FIG. 2 is a diagrammatic view of two tables in a database of one embodiment of the present invention;

FIG. 3 is a diagrammatic view of a selection from the two database tables of FIG. 2;

FIG. 4 is a diagrammatic view of a communication path of one embodiment of the present invention;

FIG. 5 is a flowchart of one feature of one embodiment of the present invention;

FIG. 6 is a flowchart of one feature of one embodiment of the present invention; and

FIG. 7 is a flowchart of one feature of one embodiment of the present invention.

Similar numbers refer to similar parts throughout the drawings.

### DETAILED DESCRIPTION

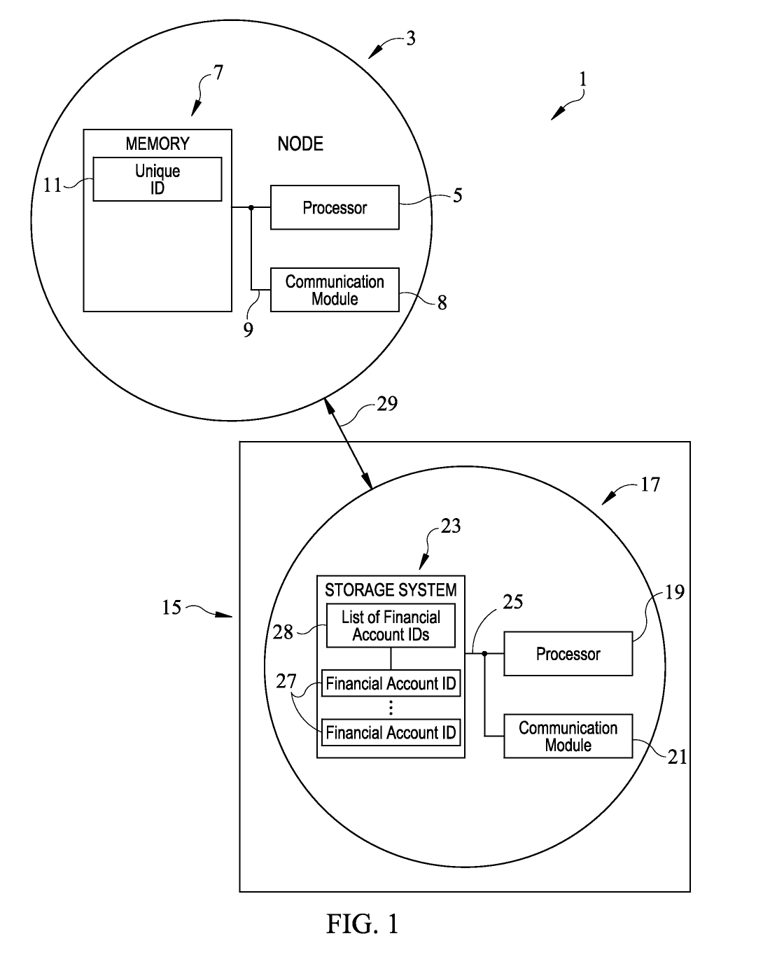

A system and method for authenticating and securing online purchases is shown in FIGS. 1-7 and referred to generally herein as system 1. Various non-novel features found in the prior art relating to encryption techniques, online transactions, network communications, and financial database systems are not discussed herein. The reader will readily understand the fundamentals of these topics are within the prior art and readily understood by one familiar therewith.

As shown in FIG. 1, system 1 includes a node 3, which may be embodied by any off-the-shelf computing component having a processor 5, a memory 7, a communication module 8, and a logic circuit 9 connecting processor 5, memory 7, and communication module 8. Thus, node 3 may be embodied by a mobile telephone, a laptop computer, a desktop computer, a tablet, or any other electronic device. Node 3 further includes a unique identifier 11, preferably stored in memory 7 and preferably represented digitally in a string of alpha numeric characters or derivable from a combination of variables stored in memory 7 or accessible by processor 5. Unique identifier 11 may be any identifier unique to node 3 and which may be used to identify only node 3. Thus, unique identifier 11 may be generated by node 3, by an external algorithm, or provided to node 3 by a third party or another part of system 1.

In one embodiment of system 1, unique identifier 11 is the media access control address (hereinafter “MAC address”) assigned to node 3. MAC addresses are unique identifiers assigned to network interfaces for communication on the physical network segment. MAC addresses are most often assigned by the manufacturer of a network interface controller (not shown) disposed in node 3 and are stored in its hardware, such as the controller's read-only memory or some other firmware mechanism. MAC addresses can be contrasted with an internet protocol address (hereinafter “IP address”), which is issued dynamically to node 3 and may be arbitrarily changed. MAC addresses are typically 48 bits long. This 48-bit address space contains potentially 2⁴⁸ or 281,474,976,710,656 possible MAC addresses. Newer machine access control schemes include 64-bit address, dramatically increasing the already large address space of the 48-bit MAC address scheme. In accordance with the above, MAC addresses are intended to be a permanent and globally unique identification mechanism for modern electronic communication devices, such as those embodied by node 3.

Unique identifier 11 may be a composite or compilation of various features stored on node 3. In one embodiment of system 1, unique identifier may be embodied by a serial number associated with node 3 appended to the MAC address. This unique identifier 11 adds a high level of security as the serial numbers of nodes 3 are generally not broadcast across communication platforms as part of the commonly used communication protocols. Given a secure encrypted communication channel between node 3 and a communication partner, this embodiment of unique identifier 11 may be used to great benefit. In another embodiment, system 1 may use a checksum algorithm to compute a checksum datum off the MAC address and/or serial number and/or an encrypted block of data stored on node 3. This checksum datum may then be used as part of unique identifier 11, for example, by appending the checksum datum to the MAC address for use as unique identifier 11.

Unique identifier 11 may be a combination of the MAC address or another string of digits and a bit-wise, decimal, hexadecimal, or any other style of representation of an image or graphic stored on node 3. For example, a user may scan a fingerprint or acquire another style of image and store the image on node 3. Unique identifier 11 may then be a bit-wise representation of the image. Alternatively, the MAC address and the photo representation may be appended to each other to form unique identifier 11. Unique identifier 11 may alternatively be a voice or speech .wav file or another type of voice-representative data file for use in forming unique identifier 11. Similarly, unique identifier 11 may incorporate a retina scan or an eye scan and the data file produced therefrom. Thus, the present invention encompasses any type of biometric data or data file which may be used and incorporated into unique identifier 11.

Unique identifier 11 may alternative be an entirely new paradigm in the computing industry, whereby computer manufacturers systematically generate and provide unique identifier 11 to all nodes 3 at the time of manufacture. This system for assigning unique identifiers 11 may be implemented by agreement between computing companies or by an industry governing body, or possibly by mandate from the federal government.

Unique identifier 11 may be constructed dynamically as needed by node 3. For example, by querying for the MAC address and the serial number of node 3 when unique identifier 11 is required. This prevents a pre-formed constructed unique identifier 11 from being stored on node 3 in an explicit manner which aids in preventing a hacker from simply downloading the file containing unique identifier 11. In the event that node 3 does detect an intrusion or a possible hacking relating to unique identifier 11, system 1 may be configured to alert law enforcement or the vendor or the financial institution of a possible fraudulent crime in progress.

Unique identifier 11 may be embodied in a phone number provided to a phone owner, which may represent node 3. Thus, the user would transmit the phone number along with the data stream when using phone as node 3 to initiate a purchase. Unique identifier 11 may be embodied in a subscriber identity module or subscriber identification module (SIM), or any subcomponent thereof. The subscriber identify module is an integrated circuit that securely stores the international mobile subscriber identity (IMSI) and the related key used to identify and authenticate subscribers on mobile telephony devices, such as mobile phones and computers. A SIM circuit may be embedded into a removable plastic card. This plastic card is called a “SIM card” and can be transferred between different mobile devices. A SIM card contains its unique serial number, international mobile subscriber identity (IMSI), security authentication and ciphering information, temporary information related to the local network, a list of the services the user has access to and two passwords: a personal identification number (PIN) for ordinary use and a personal unblocking code (PUK) for PIN unlocking. Thus, unique identifier 11 may be embodied in one of the above unique variables or any combination thereof.

Unique identifier 11 may also be embodied in a driver's license number or a license plate number or any other type of unique number or signature assigned to the owner or user of that particular node 3.

The owner or user of node 3 is also the owner or user of a financial account at a financial institution 15. As shown in FIG. 1, financial institution 15 includes a computer system 17 having at least a processor 19, a communication module 21, a storage system 23, and a logic circuit 25 connecting processor 19, communication module 21, and storage system 23. Logic circuit 25 may be dynamically formed as needed for busing data between processor 19, communication module 21, and storage system 23. Storage system 19 may be any commonly used mechanism for storing information, including a database or a plurality of databases locally disposed at financial institution 15, or disposed offsite or administered by a third party, or a combination of local and remote databases.

For organizational purposes, financial institution 15 provides a financial account identifier 27 for each account at financial institution 15. Financial account identifiers 27 may be any method for identifying an individual account, including a social security number, a unique number or combination of alpha-numeric characters, or any other mechanism or method for tracking and identifying a financial account by computer system 17. As shown in FIG. 1, a list 28 of financial account identifiers 27 are stored in storage system 23 of computer system 17 associated with financial institution 15.

As shown in FIG. 1, the owner or user of node 3 uses communication module 8 of node 3 to establish a communication link 29 to communication module 21 of financial institution 15, preferably via the World Wide Web. Communication link 29 is preferably an encrypted communication channel formed by passing login credentials and a password to financial institution 15, as typically performed in the art when logging into a system. Once communication link 29 is established, the user has the option to initiate transmitting unique identifier 11 to financial institution 15 via communication link 29. Providing the user the option of transmitting unique identifier 11 may come in the form of a website question/option button or graphic, or any other mechanism for providing the user the option to transmit or upload unique identifier 11 from node 3 to financial institution 15 via communication link 29.

Once the user of node 3 transmits unique identifier 11 to financial institution 15, financial institution 15 stores unique identifier 11 in storage system 23 and associates unique identifier 11 with the sender's financial account identifier 27 in list 28. This association can be performed using any method commonly understood in the art. For example, by entering unique identifier 11 in a field in a database table and associating that field with another field in another database table containing list 28 of financial account identifiers 27. Financial institution 15 may also store the user's name or some other way of identifying the user with respect to financial account identifier 27 as more than one user may be authorized to access that financial account and records may be kept for who is supplying which unique identifier 11. Multiple users may be linked to one financial account identifier 27 and provided with a user specific name and password, for example, if multiple employees use a company credit card to perform services for the company. Thus, the company and/or financial institution may provide and revoke a user's login and password and remove the association with a particular financial account identifier.

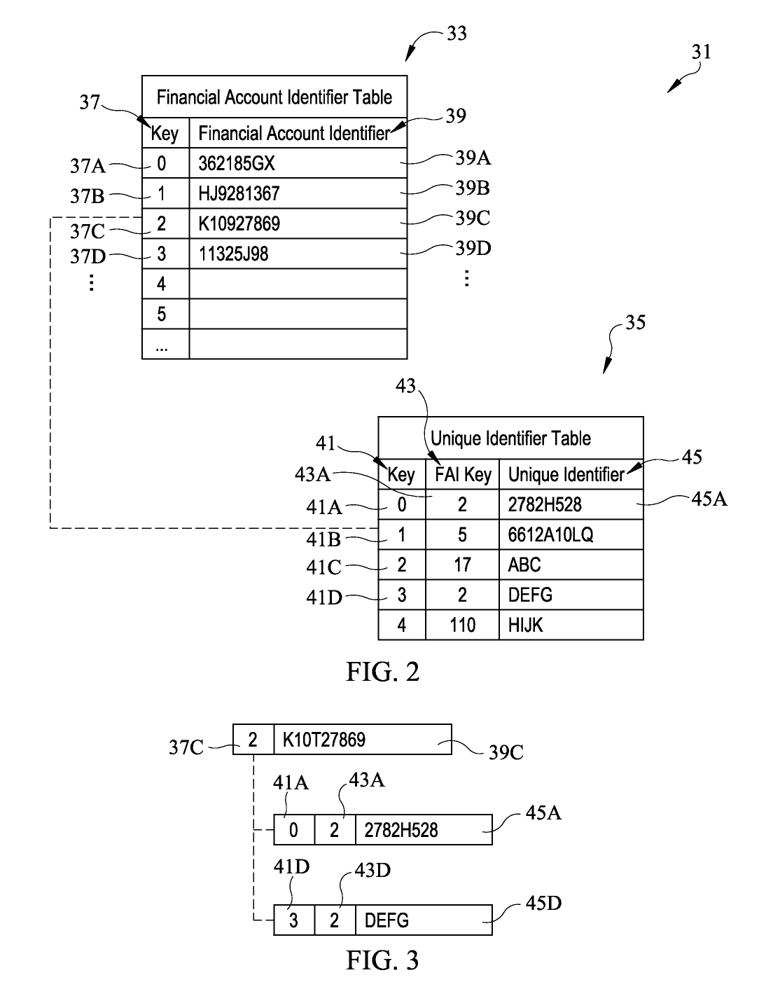

FIG. 2 shows an exemplary embodiment of the storage system 23 in the form of a database 31 containing at least two database tables, list 28 embodied as a financial account identifier table 33 and a unique identifier table 35. Financial account identifier table 33 includes a key column 37 and a financial account identifier column 39. Entries in the individual fields of key column 37 include numbers or keys unique to key column 37, for example, a linearly increasing integer such as 1, 2, 3, 4, 5, etc. Financial account identifiers 27 for all of the accounts operated by financial institution 15 are entered into individual fields in financial account identifier column 39. Therefore, each row in financial account identifier table 33 includes a key field, found in key column 37, and a financial account identifier field, found in financial account identifier field 39. Unique identifier table 35 includes a key column 41, a financial account identifier table key column 43, and a unique identifier column 45. Entries in the individual fields of key column 41 include numbers or keys unique to key column 41, for example, a linearly increasing integer such as 1, 2, 3, 4, 5, etc. Entries in the individual fields of unique identifier column 45 include unique identifiers 11 transmitted by financial account holders at financial institution 15 to be stored by database 31. Entries in the individual fields of financial account identifier table key column 43 include keys found in key column 37 of financial account identifier table 33. This reference field links financial account identifiers 27 with unique identifiers 11 in database 31.

One familiar in the art will recognize a database query may be formed to select a record from financial account identifier table 33 and thereafter select all the records in unique identifier table 35 with the financial account identifier table key column 43 equal to key column 37 of the selected record. This query will provide all of the unique identifiers 11 associated with a given financial account identifier 27. As shown in FIG. 3, for a given row in financial account identifier table 33, the corresponding row(s) of unique identifier table 35 may be ascertained and retrieved. For example, if the row containing key column 37C and financial account identifier column 39C is selected from financial account identifier table 33, the corresponding rows containing the key “2” are selected from unique identifier table 35. In this example, those rows are the rows having key column 41A and key column 410, as both financial account identifier table key columns 43A and 43D contain the reference key “2”. As such, computer system 17 provides that financial account identifier 27 found in field 39C is associated with unique identifiers 11 found in fields 45A and 45D.

After a user uploads or transmits a particular unique identifier 11 to financial institution 15 for association with the user's particular financial account identifier 27, the user may end or close communication link 29. Financial institution 15 retains the uploaded unique identifier 11 in storage system 23 for future use as an authentication and security feature. More particularly, financial institution 15 only permits a financial transaction involving that financial account identifier 27 if the request for a financial transaction is initiated from a particular node 3 having a matching unique identifier 11 stored in storage system 23. In essence, financial institution 15 blocks all financial transactions involving a particular financial account associated with financial account identifier 27 which are not initiated via a node 3 having a previously uploaded unique identifier 11 associated with financial account identifier 27. All requests for financial transactions initiated on non-authenticated nodes 3 are blocked and/or refused, preventing unauthorized financial transactions. As such, even if all of the user's financial information and credentials are stolen (financial account number, login ID, login password, etc.) financial transactions involving the compromised account are still prevented if the thief is not using an authorized node 3 to facilitate the fraudulent financial transactions.

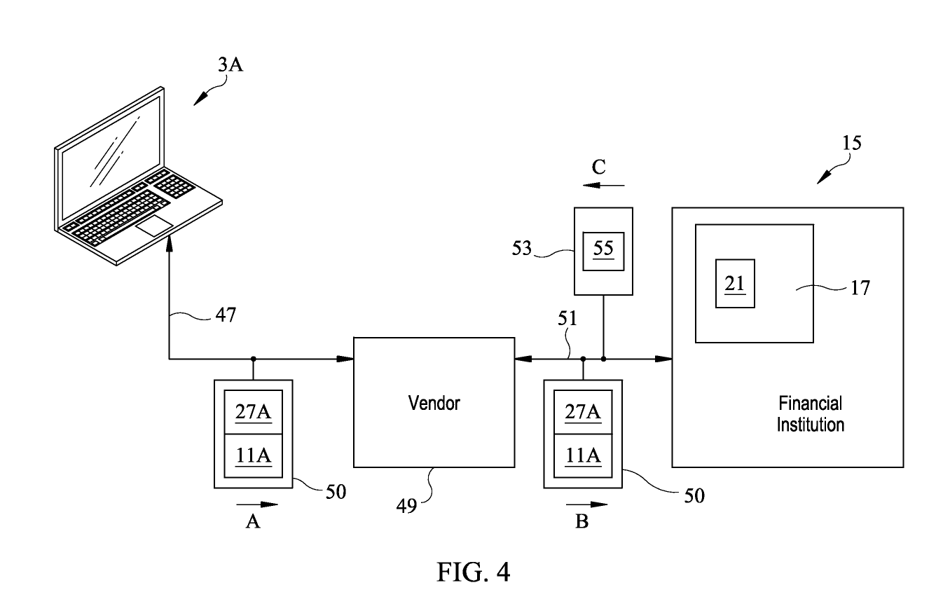

Often, an individual wishes to initiate a financial transaction with a vendor. Therefore, the three parties to the financial transaction must coordinate and authenticate the financial transaction. As shown in FIG. 4, a user uses node 3A to establish a communication link 47 with a vendor 49. Vendor 49 provides a good or service in exchange for payment. Vendor 49 may be an online retailer such as Amazon® or a similar online storefront or commercial entity such as an airline ticket payment system. In this example, the user of node 3A wishes to buy a widget from vendor 49 for a particular price. The user of node 3A actuates a purchase mechanism provided by vendor 49, which transmits a data packet 50 from node 3A to vendor 49 in the direction of Arrow A. Data packet 50 includes the user's financial account identifier 27A and unique identifier 11A of node 3A. Vendor 49 receives data packet 50 and in turn establishes a communication link 51 with financial institution 15. Vendor 49 then forwards or transmits data packet 50 to financial institution 15 over communication link 51 and in the direction of Arrow B. Using computer system 17, financial institution 15 retrieves any unique identifiers 11B, 11C, etc. associated with financial account identifier 27A. Processor 19 (FIG. 1) then compares the received unique identifier 11A with the stored unique identifiers 11B, 11C, etc. and determines whether unique identifier 11A matches one of the stored unique identifiers 11B, 11C, etc.

Thereafter, a data packet 53 is constructed and sent via communication link 51 from financial institution 15 to vendor 49 in the direction of Arrow C. Data packet 53 contains an answer 55. Answer 55 is the result of the comparison of whether unique identifier 11A matches any unique identifiers 11B, 11C, etc. stored in storage system 23 (FIG. 1) and linked to financial account identifier 27A. For example, processor 19 (FIG. 1) may determine that unique identifier 11A precisely matches stored unique identifier 11B. In this scenario, financial institution 15 transmits data packet 53 with an agreed upon message indicating that the financial institution 15 agrees to facilitate the requested financial transaction between the user and vendor 49. Financial institution 15 then transmits the requested amount from user's account at financial institution 15 to vendor 49 and the transaction is successfully completed. Conversely, processor 19 (FIG. 1) may determine that unique identifier 11A does not match any stored unique identifiers 11B, 11C, associated in storage system 23 (FIG. 1) with financial account identifier 27A. In this scenario, financial institution 15 transmits data packet 53 with an agreed upon message indicating that financial institution does not agree to facilitate the requested financial transaction between the user and vendor 49. Thereafter, financial institution 15 does not transfer any funds from the user's account at financial institution 15 to vendor 49. System 1 may implement further logic or system methods to alert the owner of the financial account associated with financial account identifier 27A that a fraudulent charge was attempted with the account owner's financial information. These alerts may take the form of emails, text messages, or phone calls.

The portion of system 1 residing on node 3 may be embodied in a precompiled and downloadable application which provides all of the benefits and features described above relating to node 3. Thus, a user may purchase an application to provide these features or an entity such as financial institution 15 may provide the application for free. The user then downloads and installs the application on node 3, which may be a phone, tablet, laptop computer, or any other type of computing device. The application may be programmed to read the node's unique identifier 11 and provide said unique identifier 11 to financial institution 15 for the initialization of system 1. Thereafter, application may provide unique identifier 11 to either vendor 49 or financial institution 15 depending on the user's input and desires. The application may be precompiled and downloadable from online marketplaces such as iTunes® or Amazon® or from the financial institution's website.

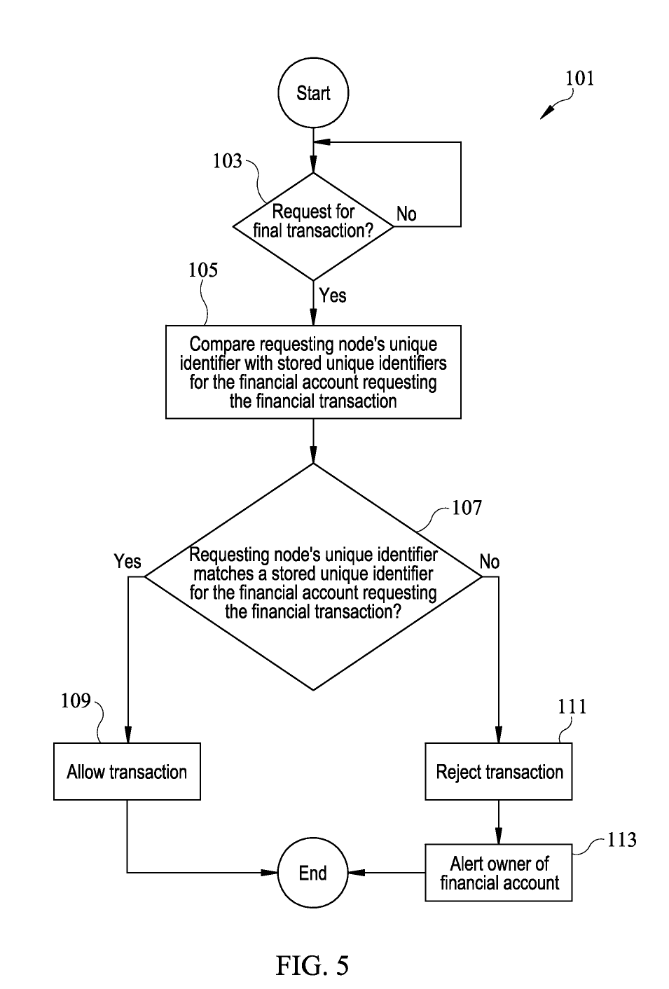

As shown in FIG. 5, system 1 may include a method 101. Method 101 relates to determining whether a request for a financial transaction is authentic or fraudulent. Method 101 starts and moves to a step 103. Step 103 determines whether the request for a financial transaction was made. If such a request was made, step 103 moves to a step 105. If such a request was not made, step 103 loops back on itself to continuously consider whether a request for a financial transaction has been made. Step 105 compares the requesting node's unique identifier with any stored identifiers for the financial account requesting the financial transaction. Thereafter, step 105 moves to a step 107. Step 107 determines whether the requesting node's unique identifier matches a stored unique identifier for the particular account requesting the financial transaction. If step 107 determines that there is a match, step 107 moves to a step 109. If step 107 determines that there is not a match, step 107 moves to a step 111. Step 109 allows or approves the requested transaction and thereafter ends method 101. Step 111 disallows or disapproves of the requested transaction and thereafter moves to a step 113. Step 113 alerts the owner of the financial account who requested the failed transaction. This may be via email, text message, phone call, or any other mechanism for alerting the listed owner of the account. Method 101 ends after step 113 is complete.

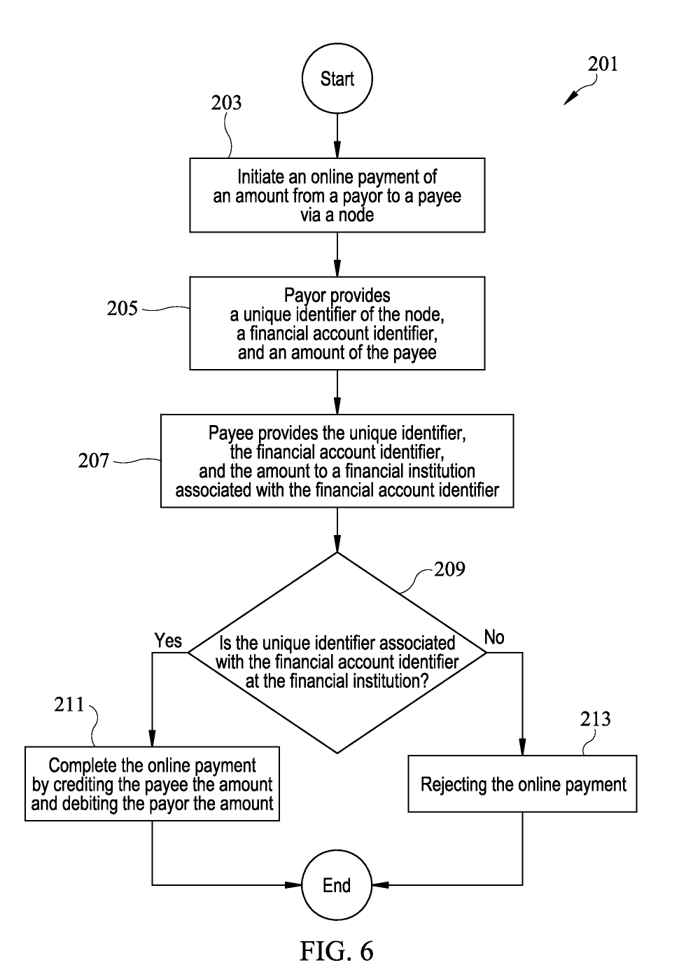

As shown in FIG. 6, system 1 may include a method 201. Method 201 relates to authenticating and securing online purchases. Method 201 starts and moves to a step 203. Step 203 initiates an online payment of an amount from a payor to a payee via a node. After step 203 completes, step 203 moves to a step 205. In Step 205, the payor provides a unique identifier of the node, a financial account identifier, and an amount to the payee. After step 205 completes, step 205 moves to a step 207. In step 207, the payee provides the unique identifier, the financial account identifier, and the amount to the financial institution associated with the financial account identifier. After step 207 completes, step 207 moves to a step 209. Step 209 determines whether the unique identifier is associated with the financial account at the financial institution. If step 209 determines that the unique identifier is associated with the financial account at the financial institution, step 209 moves to a step 211. If step 209 determines that the unique identifier is not associated with the financial account at the financial institution, step 209 moves to a step 213. In step 211, the online payment is completed by crediting the payee the amount and debiting the payor the amount. Method 201 ends after step 211 is complete. In step 213, the online payment is rejected and not completed. Method 201 ends after step 213 is complete.

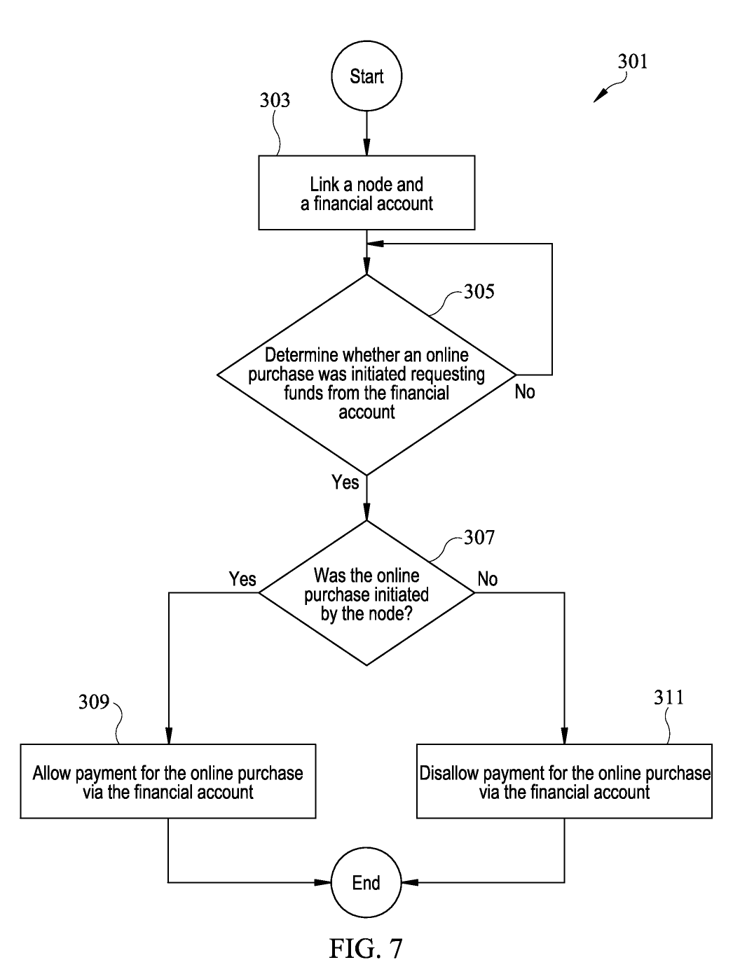

As shown in FIG. 7, system 1 may include a method 301. Method 301 relates to authenticating and securing online purchases. Method 301 starts and moves to a step 303. Step 303 links a node and a financial account and moves to a step 305. Step 305 determines whether an online purchase was initiated requesting funds from the financial account. If step 305 determines that an online purchase was initiated requesting funds from the financial account, step 305 moves to a step 307. If an online purchase was not initiated requesting funds from the financial account, step 305 loops back on itself. Step 307 determines whether the online purchase requesting funds from the financial account was initiated by the node. If step 307 determines that the online purchase was initiated by the node, step 307 moves to a step 309. If step 307 determines that the online purchase requesting funds from the financial account was not initiated by the node, step 307 moves to a step 311. Step 309 allows payment for the online purchase via the financial account. Method 301 ends after step 309 is complete. Step 311 disallows payment for the online purchase via the financial account. Method 301 ends after step 311 is complete.

“Logic,” “logic circuitry,” or “logic circuit,” as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

In the foregoing description, certain terms have been used for brevity, clearness, and understanding. No unnecessary limitations are to be implied therefrom beyond the requirement of the prior art because such terms are used for descriptive purposes and are intended to be broadly construed.

While the present invention has been described in connection with the preferred embodiments of the various figures, it is to be understood that other similar embodiments may be used or modifications and additions may be made to the described embodiment for performing the same function of the present invention without deviating there from. Therefore, the present invention should not be limited to any single embodiment, but rather construed in breadth and scope in accordance with the recitation of the appended claims.

1. A method for authenticating and securing online purchases, the method comprising the steps of:
initiating an online payment of an amount from a payor to a payee, wherein the payor initiates the online payment via a computer system;
providing, by the payor, a unique identifier of the computer system, a financial account identifier, and an amount to the payee;
providing, by the payee, the unique identifier, the financial account identifier, and the amount to a financial institution associated with the financial account identifier;
determining, by the financial institution, whether the unique identifier is associated with the financial account identifier;
completing the online payment by crediting the payee the amount and debiting the payor the amount if the unique identifier is associated with the financial identifier; and
rejecting the online payment if the unique identifier is not associated with the financial identifier.

2. The method of claim 1, further providing the steps of:
assigning a media access control address to the computer system; and
providing the media access control address as the unique identifier.

3. The method of claim 2, further comprising the step of assigning the unique identifier to the computer system by a third party.

4. The method of claim 3, further comprising the step of storing the unique identifier in a read-only memory disposed in the computer system.

5. The method of claim 1, further comprising the steps of:
assigning a serial number to the computer system;
assigning a media access control address to the computer system; and
providing the unique identifier as a combination of the serial number and the media access control address.

6. The method of claim 5, further comprising the step of appending the serial number and the media access control address to provide the unique identifier.

7. The method of claim 1, further comprising the steps of:
assigning a media access control address to the computer system;
executing an algorithm to provide a checksum datum as the result of the algorithm;
providing the unique identifier as a combination of media access control address and the checksum datum.

8. The method of claim 1, further providing the steps of:
providing, by the payor, the unique identifier to the financial institution; and
associating the unique identifier and the financial account identifier of the payor in a storage system of the financial institution.

9. A method for authenticating and securing online purchases, the method comprising the steps of:
linking a node and a financial account, wherein the node includes a processor, a memory, and a logic circuit;
allowing payment for online purchases via the financial account when the online purchase is initiated by the node; and
disallowing payment for online purchases via the financial account when the online purchase is not initiated by the node.

10. The method of claim 9, further comprising the steps of:
providing the node with a unique identifier; and
associating the unique identifier with the financial account to link the node and the financial account.

11. The method of claim 10, further comprising the steps of:
assigning a media access control address to the node; and
providing a media access control address as the unique identifier.

12. The method of claim 11, further comprising the step of storing the media access control address of the node in a storage system operated by a financial institution, wherein the financial institution is associated with the financial account.

13. The method of claim 10, further comprising the step of appending one of a serial number of the node and a checksum datum computed by the node with a media access control address of the node to form the unique identifier.

14. The method of claim 10, further comprising the steps of:
transmitting the unique identifier to a vendor from the node when the online purchase is initiated by the node; and
transmitting the unique identifier from the vendor to a financial institution associated with the financial account.

15. A method for authenticating and securing online purchases, the system comprising:
storing a plurality of financial account identifiers in a storage system of a financial institution;
associating a first financial account identifier in the plurality of financial account identifiers with an account holder of the financial institution;
entering a first unique identifier of a node associated with the account holder into a plurality of unique identifiers in the storage system of the financial institution; and
associating the first unique identifier with the first financial account identifier in the storage system.

16. The method of claim 15, further comprising the steps of:
receiving a request for a financial transaction from a merchant, wherein the request includes a first data and a second data;
selecting a second financial account identifier from the plurality of financial account identifiers, wherein the second financial account identifier matches the first data;
selecting a second unique identifier from the plurality of unique identifiers, wherein the second unique identifier is associated with the second financial account identifier in the storage system;
comparing the second unique identifier and the second data;
granting the request for the financial transaction if the second unique identifier matches the second data; and
denying the request for the financial transaction if the second unique identifier does not match the second data.

17. The method of claim 16, further comprising the step of providing the first data and the second data to the merchant from a node.

18. The method of claim 17, further comprising the steps of:
logging into the merchant from the node using a login identification and a password; and
transmitting the first data and the second data to the merchant from the node.

19. The method of claim 17, further comprising the step of providing a media access control address of the node as the second data.

20. The method of claim 17, further comprising the step of notifying an account holder associated with the second financial account identifier if the second unique identifier does not match the second data.
